(19) United States
(12) Patent Application Publication
(10) Pub. No.: US 2019/0130443 A1
(43) Pub. Date: May 2, 2019

(54) USABLE INTERFERENCES BASED ON A USER'S UPDATED DIGITAL PROFILE

(71) Applicant: Michael Antzoulis, Boonton Township, NJ (US)

(72) Inventor: Michael Antzoulis, Boonton Township, NJ (US)

(21) Appl. No.: 15/800,790

(22) Filed: Nov. 1, 2017

(51) Int. Cl. G06Q 30/02; G06Q 50/00

(52) U.S. Cl. CPC G06Q 30/0251; G06Q 50/01

(57) ABSTRACT

A lost and found service supported on a server is configured to aid users in finding lost items by storing lost item data and comparing the lost item data to found item data that is submitted by a remote user who claims to have found the item. The service can compare the data until it identifies a match and transmit an alert to both users when a match occurs. Users can access the service using a lost and found client that is part of a stand-alone application or a separate application such as a social network application through which the user can access the lost and found client. The lost item data can also be used to update a user's digital profile to reflect the user's interest and value in that particular product, and use that information to transmit relevant advertisements to the user.

### BACKGROUND

People often lose personal items and memorabilia during their everyday lives, such as at school, work, restaurants, sporting events, and while on vacation. Some of these places may have a designated area or department for lost and found items to which people can turn to hopefully retrieve their lost items. At times, users never locate their lost items and need to search for and purchase a replacement.

### SUMMARY

A cloud-based lost and found service supported on a server is configured to receive lost item reports and found item reports from people who have lost an item and found an item, respectively, and compare the reports to recover lost items more efficiently. The lost and found service can interoperate with a third-party service operated by an organization, such as an amusement park, to provide a more useful and efficient lost and found experience for service users. The amusement park may release their own application that is installed on a user's computing device and which interacts with their server, and a lost and found client may be incorporated into the amusement park's application for users to upload lost item reports and found item reports to the lost and found service. The lost and found client provides easy and quick accessibility to the lost and found service's features for the amusement park's user base, typically within an identifiable geographic region. The lost and found service can also interoperate with social networking applications, in which users can upload lost item reports and found item reports. Users may designate a geographic region, name of a place or institution, etc. where an item was lost or found.

With notice to users and user consent, the lost and found service can collect data about users of the lost and found service. For example, for users submitting a lost item report, the lost and found service may create a profile that reflects that user's interest in a particular item or category of items. Based on the user profile, and the profiles of other similar users, the lost and found service can deliver personalized advertisements that show potential replacements for lost items or related items that may be responsive to the user's interests. For example, if the user lost a guitar at a university campus, after a predetermined time period has elapsed, and no user has submitted a found item report, or the user has not cancelled the lost item report, then the lost and found service can deliver an advertisement to the user for suitable replacement guitars. If the lost and found service is incorporated within an application released by the university, the advertisement can be displayed as a banner or other form of advertisement within the university's application. The advertisement can include guitars of a similar make, model, or price range, and can likewise include related items such as guitar strings, music notebooks, guitar picks, and other accessories.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It may be appreciated that the above-described subject matter may be implemented as a computer-controlled apparatus, a computer process, a computing system, or as an article of manufacture such as one or more computer-readable storage media. These and various other features may be apparent from a reading of the following Detailed Description and a review of the associated drawings.

### DESCRIPTION OF THE DRAWINGS

FIG. 1 shows various illustrative headings for locations which users attend;

FIG. 2 shows illustrative items that users can lose at the various locations;

FIG. 3 shows an illustrative system architecture of a computing device with a lost and found client;

FIG. 4 shows an illustrative system architecture for a computing device with a lost and found client;

FIG. 5 shows an illustrative environment with which client devices interact over a network with a lost and found service and a social network service;

FIG. 6 shows an illustrative lost item form accessed by a user using the lost and found client;

FIG. 7 shows a lost item form as illustratively completed;

FIG. 8 shows an illustrative drop-down menu for a manufacturer section;

FIG. 9 shows an illustrative drop-down menu for a model number section;

FIG. 10 shows an illustrative environment in which the user's computing device transmits the completed lost item form to the lost and found service;

FIG. 11 shows an illustrative environment in which a remote user device transmits a completed found item form to the lost and found service;

FIG. 12 shows an illustrative data comparison between the lost item form and found item form at the lost and found service;

FIG. 13 shows an illustrative table for an incentive program provided to users who find lost items;

FIG. 14 shows an illustrative update to a digital profile using lost item data at a social network;

FIG. 15 shows illustrative advertisements transmitted to the user's computing device based on the updated digital profile;

FIG. 16 shows illustrative product variations for products related to the lost item;

FIG. 17 shows illustrative categorical items for a particular exemplary lost item;

FIGS. 18-20 show illustrative processes performed by one or more of a lost item service, social network service, or client computing devices;

FIG. 21 shows a block diagram of an illustrative device that may be used in part to implement the present usable inferences based on user's updated digital profile; and

FIG. 22 is a block diagram of an illustrative device such as a mobile phone or smartphone.

Like reference numerals indicate like elements in the drawings. Elements are not drawn to scale unless otherwise indicated.

### DETAILED DESCRIPTION

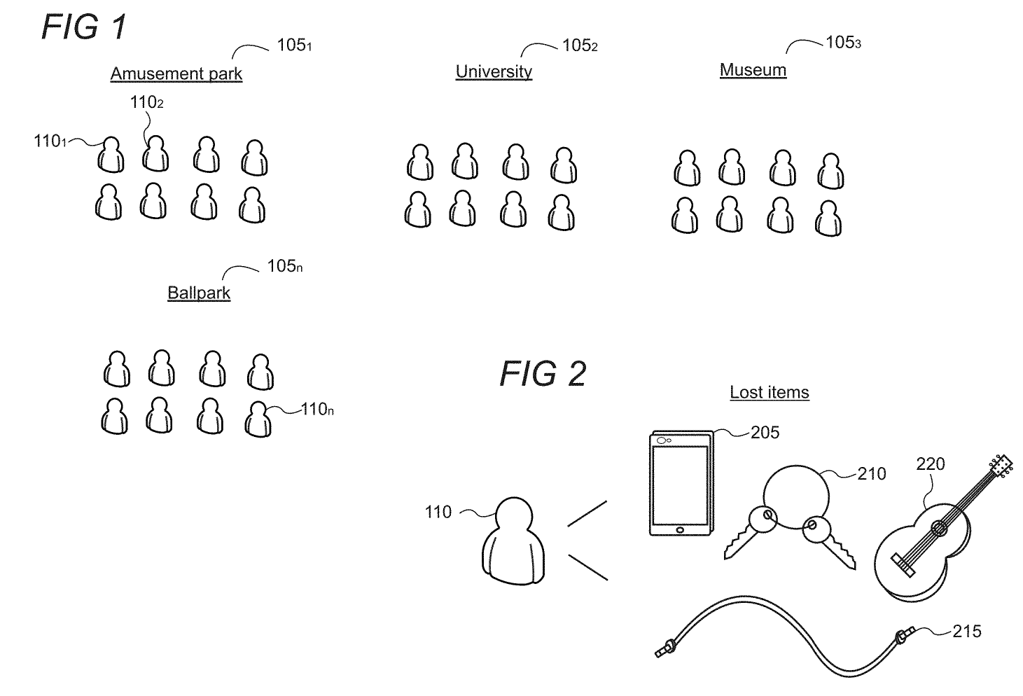

FIG. 1 shows an illustrative group of headings associated with various locations, places, and establishments, represented by numeral 105, which people and users 110 of the present cloud-based lost and found service can visit. The various locations include an amusement park, university, museum, and ballpark, each of which can accommodate users 110 for various purposes including education, entertainment, and the like. The places depicted in FIG. 1 are intended to be illustrative, and not an exhaustive list, and other places not shown, such as public parks, coffee shops, retail stores, restaurants, etc., may also be locations with which the present usable inferences based on user's updated digital profile may be utilized.

Users typically lose or misplace personal items when visiting the locations 105. FIG. 2 provides illustrative examples of items that may be lost and includes a smartphone 205, keys 210, jump rope 215, and a guitar 220. Generally, the various locations 105 may have their own respective lost and found departments that can be accessed by users to potentially retrieve their lost items. These lost and found departments can at times be difficult to locate by users who have lost an item and by those who want to drop off a found item. Users may also not realize that they have even lost an item until they have left the location and are already home.

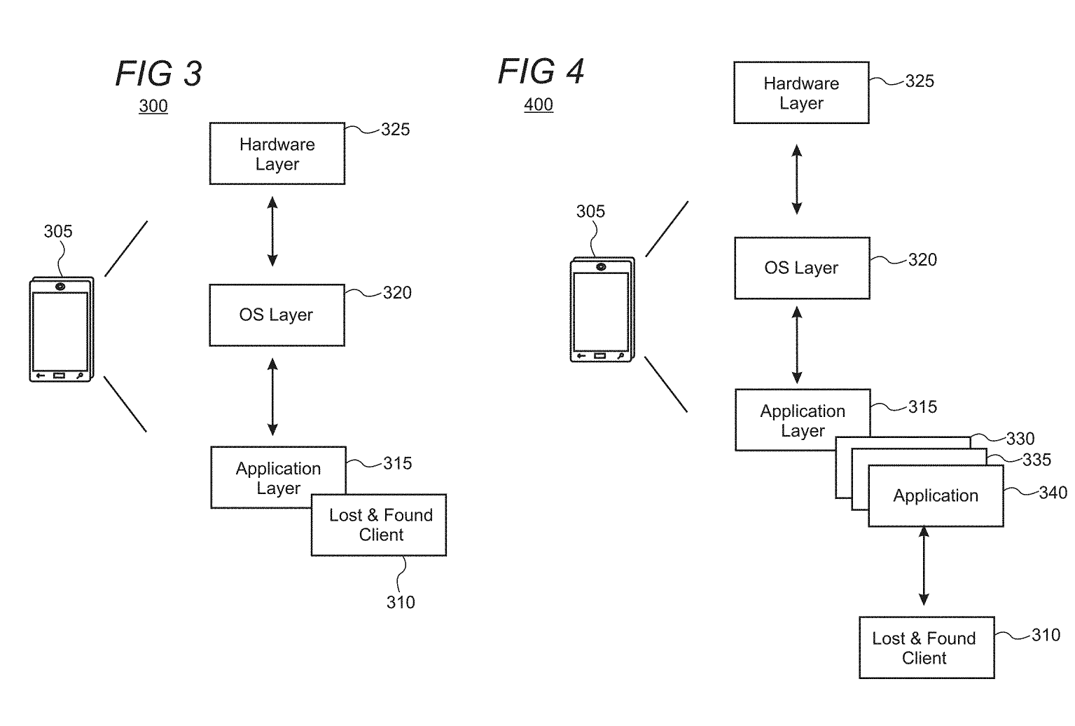

FIG. 3 shows an illustrative system architecture for a computing device 305 associated with the user 110, which implements a lost and found client application 310. Although a smartphone 305 is depicted in FIG. 3, other computing devices are also envisioned including tablet computers, laptop computers, personal computers, wearable devices such as head mounted display devices, and the like. The computing device, in simplified form, may include an application layer 315, operating system (OS) layer 320, and a hardware layer 325. The application layer provides various services to a user such as the lost and found client 310, in addition to other applications such as a calculator, maps, word processor, calendar, internet browser, etc. (not shown). The applications may coordinate with a GUI (graphical user interface), in which the user selects an icon in the GUI to load and launch a particular application, for example, by interacting with a touchscreen display, using voice command, or using a pointing device.

The applications and GUI interfaces may interoperate with the OS layer 320. The OS layer can manage the system resources, provide the GUI for the user, and control operation of applications. Thus, if a user selects an application, the OS layer can execute the functions and processes associated with the selected application, such as enabling the calculator or maps to execute on the device. In addition, the OS layer may interoperate with the hardware layer 325 and manage the various hardware components. For example, the hardware layer can include abstractions of one or more processors such as central processing units (CPU) and graphic processing units (GPU), memory (e.g., hard-disk drive, flash memory, etc.), and also user input/output devices such as a pointing device (e.g., mouse), or microphone.

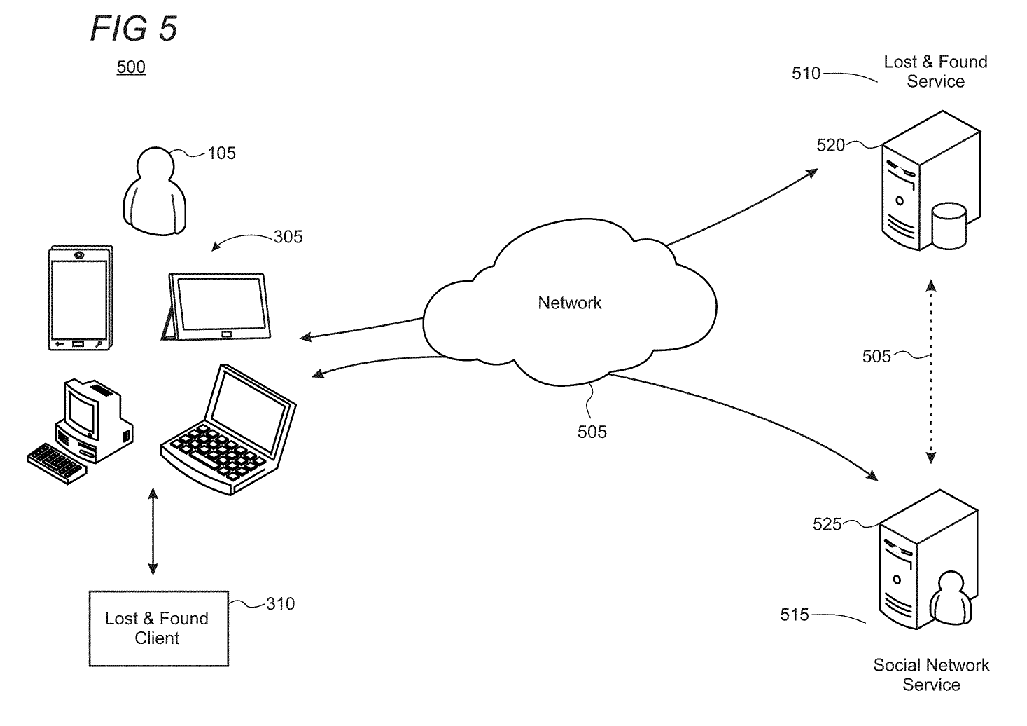

FIGS. 3 and 4 show illustrative system architectures 300 and 400 for computing devices 305 with which a lost and found client 310 can operate to help a user retrieve their lost item. FIG. 4 includes another rendition of the system architecture of FIG. 3, but here the user may access the lost and found client 310 as a component within a distinct application 330, 335, or 340 on their device. Exemplary applications with which the lost and found client can be a component include a social network application or proprietary applications associated with actual locations/establishments, such as a ballpark, museum, amusement park, and the like. This way when a user loses an item within, for example, an amusement park, the user can access the lost and found client through the amusement park's application. In another example, the user can access a web browser application and access a uniform resource locator (URL) which directs the user to a lost and found service.

FIG. 5 shows an illustrative environment 500 in which the lost and found client 310 communicates over network 505 with a lost and found service 510 and/or a social network service 515 operating on servers 520 and 525, respectively. As discussed above with respect to FIGS. 3 and 4, the lost and found client may be a stand-alone application on the user's device which communicates with the lost and found service (FIG. 3) or the client may be a component within an application and thereby communicate directly with the social network service (FIG. 4).

Although FIG. 5 depicts a social network service as the application with which the lost and found client operates, other services as discussed above are also possible, including a service associated with a museum, amusement park, etc. Thus, each establishment with an application or a method in which a user can access their service such as using a URL through a browser, can have a lost and found client. The social network service depicted in FIG. 5 and throughout the figures is representative only, and can be replaced with other third-party or proprietary applications such as for a museum, university, or amusement park.

The network 505 may include any environment, components, or infrastructure that provides connections to devices at network nodes and may include personal area network (PAN), local area network (LAN), wide area network (WAN), the Internet, World Wide Web, etc., and combinations thereof.

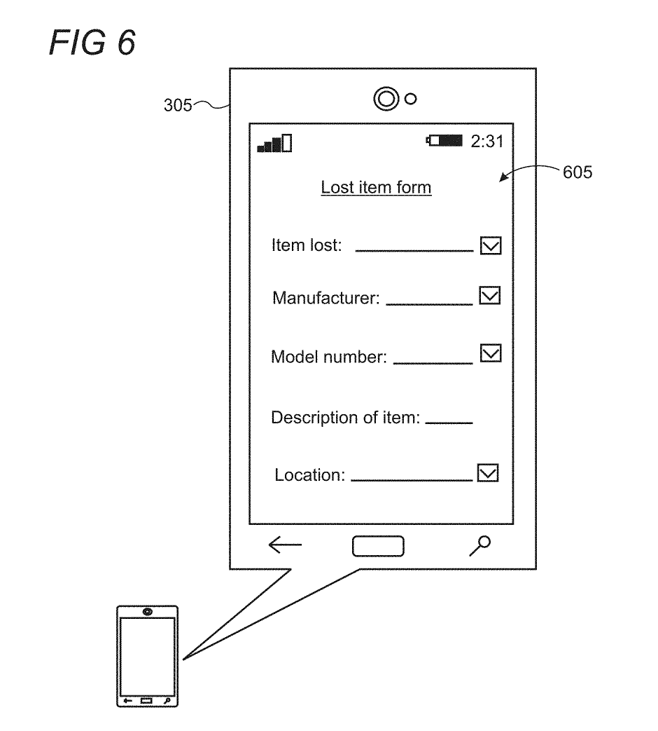

The lost and found client 310 can include its own set of features and operations and interact with the lost and found service. For example, FIG. 6 shows an illustrative lost item form 605 which the user accesses through the lost and found client 310. Exemplary portions of this form include descriptions for the lost item, manufacturer, model number, and the location where the item was lost.

The user may access the lost item form by selecting an option within the client.

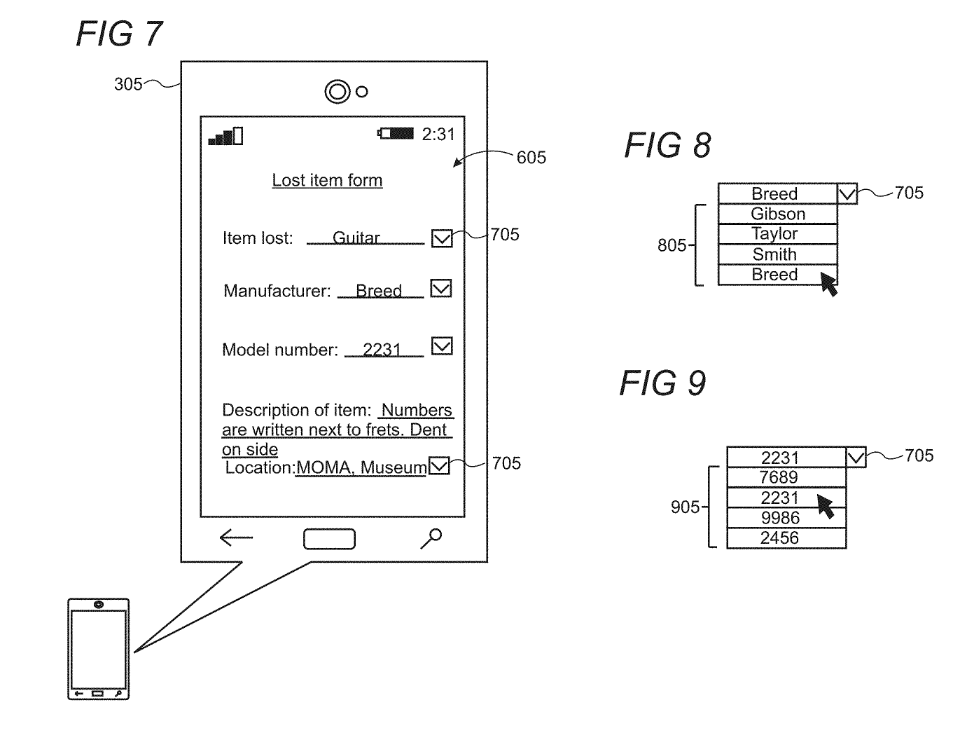

FIG. 7 shows the illustrative lost item form 605 filled out for a guitar which the user lost. The completed form indicates details about the user's lost guitar, including the name of the manufacturer, model number, details about the particular lost guitar, and that the guitar was lost at the Museum of Modern Art (MOMA). In this exemplary embodiment for the form, the user can select drop down menus 705 to select among pre-set choices. For example, the lost and found service and/or client may store pre-set items to make it easier for users to particularize details about their lost items.

FIGS. 8 and 9 show illustrative, pre-set names for manufacturers 805 and model numbers 905 associated with the selected manufacturer, respectively. Although not shown, pre-set items can be used for the item lost (e.g., jump rope, guitar, keys) and location (e.g., central park, restaurant name, ballpark). In another embodiment, the user can provide input into the form if any of one or more of the pre-set choices are insufficient in describing the lost item.

The pre-set choices may allow the lost item service to aptly organize items within their respective categories. For example, the service may store lost items according to categories, such as sporting goods, musical instruments, toys, electronic devices, and the like. In this regard, the form may have prompted the user to select a broader category (e.g., music) to hone in on the guitar selection as depicted in FIG. 7.

The form may include additional sub-parts in which the user can select or input his own description. For example, when the user selects MOMA as the location, additional questions may populate such as, if known, which floor the user may have lost the item (e.g., first floor, second floor) and which department the user lost the item (e.g., drawings, film, photography). Alternatively, the user can independently input such data. Each category can include sub-parts as well, such as if a manufacturer has a particular product line for the item, and model number such as if the item has multiple versions.

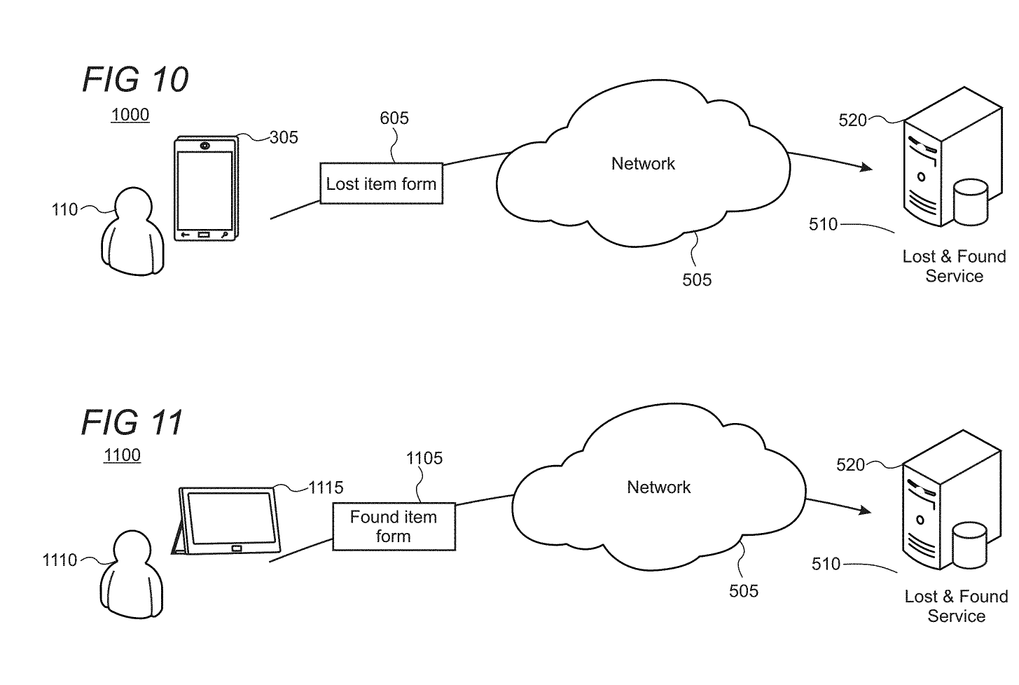

FIG. 10 shows an illustrative environment 1000 in which the user 110 transmits the completed lost item form 605 to the lost and found service 510. Although FIG. 10 depicts transmission to the lost and found service, the user can alternatively transmit the form to the social network service 515 (FIG. 5) which interacts with—that is, transmits to and receives data from, the lost and found service. The user's device may transmit the data to the social network service in the scenario where the user accesses the lost and found client using the social network application, which then forwards the data to the lost and found service. Alternatively, the data may be transmitted directly to the lost and found service from the social network application.

FIG. 11 shows an illustrative environment 1100 in which a remote user 1110, using tablet computer 1115, transmits a found item form 1105 to the lost and found service 510. In this scenario, the remote user 1110 found an item that, at this point, may or may not be related to the user's lost guitar. The found item form may include similar details and inquiries as the lost item form to properly compare the details. Similar to the lost item form, the data in the found item form may be transmitted directly to the lost item service or alternatively to the social network service which thereby transmits the data to the lost and found service.

As an alternative embodiment, if the user is communicating through a third-party application, such as a messaging application or a social network application, the application may identify keywords from the one or more messages and prompt the user with the lost item form or the found item form, depending on the scenario. For example, if the user communicates to someone that they lost their guitar, then the application may identify keywords such as “lost” and “guitar,” and offer the user with the lost item form to fill out. The application may further incorporate detected terms into the form for the user's convenience, such as the term “guitar.” If the user indicated a location where they lost the item, the form can likewise populate the form with the identified location. Similar automatic population of the found item form can be implemented in the scenario in which a user communicates that they have found an item. For example, if a user inputs “I just found an iPhone on the seat of a bus stop,” the form may identify the terms “iPhone” and “bus stop,” and thereby populate the form with such information. If the user's location information is identifiable, then the given address for that bus stop may be populated. Alternatively, the agency that operates the bus terminals may be identified as the location/establishment.

Such recognition and identification of key words can be detected beyond a messaging application, such as by posts or comments on a social network (e.g., Facebook®), posts or comments in open or closed groups like community help groups, and other forums or mediums in which users can communicate with other people or users. For example, users can subscribe to various groups including groups designated for universities, communities, and the like, in which comments to those particular forums can be recognized, identified, and then automatically populated into a form by the lost and found client to create a seamless user experience.

In this regard, lost and found client 310 or service 510 can be configured with an AI (artificial intelligence) component to intelligently determine whether a user has lost an item, the item which was lost, and a location where the user lost the item. In addition, the client 310 or service 510 can also intelligently determine whether a user has found a lost item, the item which was found, and a location where the user found the item. Upon determining this information, the client can automatically populate the respective lost item form or found item form for the user.

For example, the AI component can detect behaviors from the user and based on the behavioral indicators deduce that the user may have lost or found an item. Behaviors that can lead the AI component to deduce that the user lost or found an item can include inputs into the computing device by the user. For example, with the user's consent the AI component can recognize words communicated to one or more other uses such as through text, e-mail, auditorily, and the like. The AI component can also make deductions based on recognized web activity (e.g., web searches through an internet browser), location tracking, and the like. Using one or more of these behavioral indicators the AI component can determine that the user may have lost an item and even detect the item which was lost.

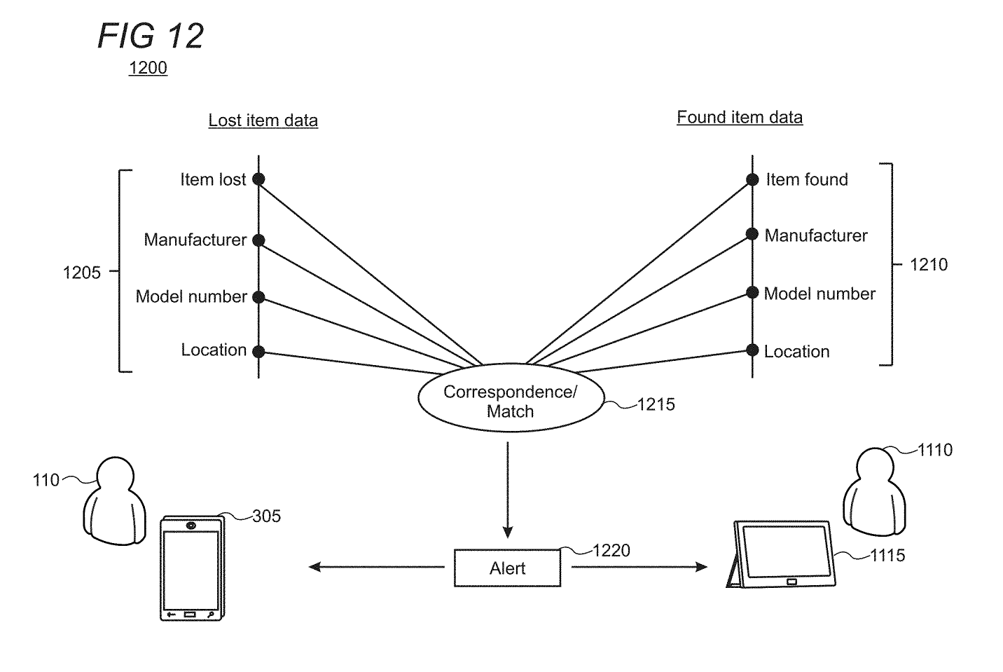

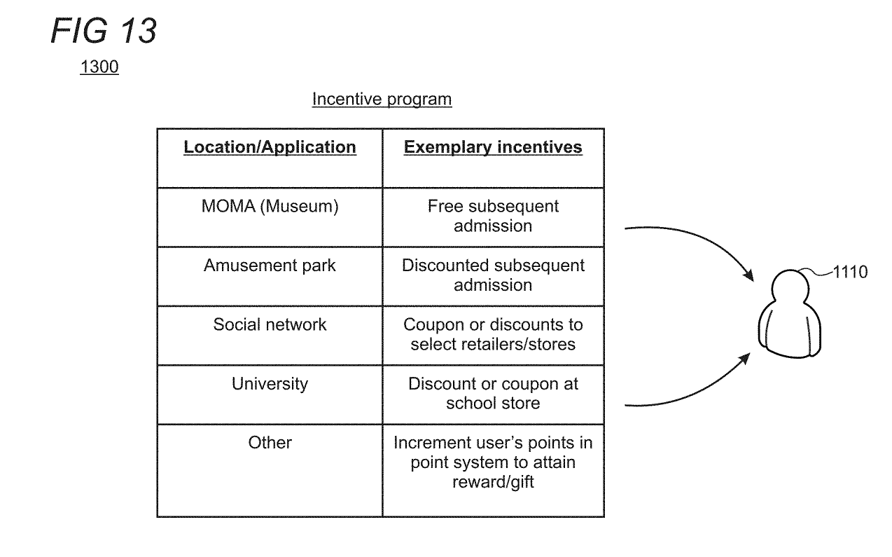

FIG. 12 shows an illustrative diagram 1200 in which the lost and found service compares the details contained in the lost item form and the found item form, from which the service derives the lost item data 1205 and found item data 1210. As illustrated, the lost item data 1205, which includes data that describes the item lost, manufacturer, model number, and location are compared with similar data in the found item data 1210. The comparison can include comparing categories with which data is associated and text among like categories (e.g., model number to model number), while still taking into account potential spelling or grammatical errors in scenarios in which users independently input data. The details compared in FIG. 12 are exemplary, and additional details and input may also be compared as discussed with respect to FIG. 7, such as sub-parts of data (e.g., a particular floor in which the user lost the item). In this regard, each portion of data including sub-parts of categories can be compared with each other to determine a correspondence or match.

When the lost and found service determines that there is a correspondence 1215, or match, beyond a requisite threshold, the service can transmit an alert 1220 to the devices for users 110 and 1110. The threshold may require that certain amounts of data match, such as having the same product and the same location in which the product was lost and found. For example, if there may be multiple entries on the form that the users 110 and 1110 completed, so a threshold for a certain number of entries can be set in order to trigger the correspondence.

The alert can occur as a notification through the application used to submit the requisite forms (e.g., social network application or lost and found application), an e-mail, text message, phone call, or any combination thereof. In the scenario in which the alert is transmitted from the social networking service, the lost and found service may have first transmitted a like signal to the social network to begin the alert process.

FIG. 13 shows an illustrative diagram 1300 of an incentive program which a company or establishment may implement to provide an incentive for users to locate and report found items that appear abandoned or lost. For example, the table provides various exemplary incentives that may be implemented by any number of places, including MOMA, an amusement park, a social network, a university, and other associations. The exemplary incentives can include any one or more of free or discounted admission for a subsequent visit or a coupon or discount to select stores. In another example, a point system may be implemented in which users accrue points that can be used to recover a reward. There may be levels within this point system such that the more points attained, the greater gift of which the user can take advantage. Alternatively, a monetary system can be implemented in which, instead of receiving points, the user can be given a small monetary gift.

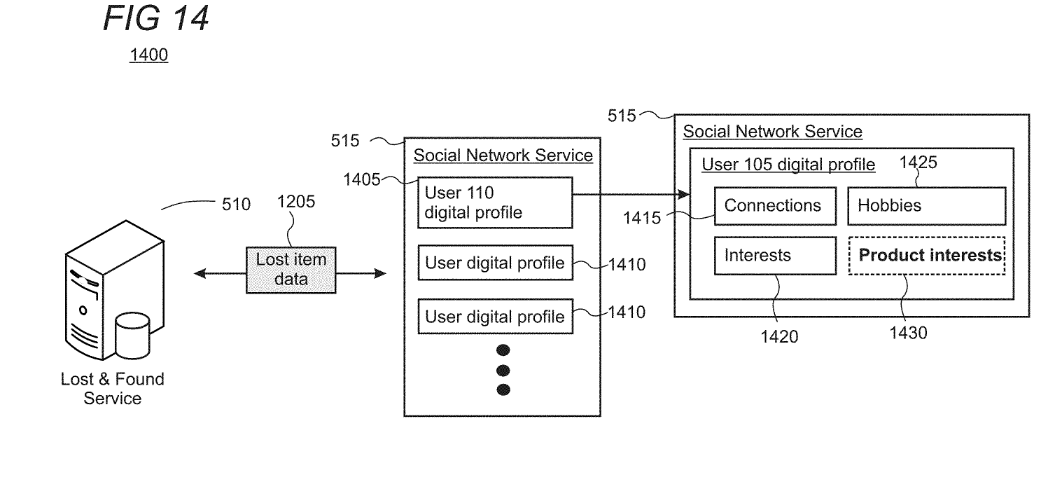

FIG. 14 shows an illustrative environment 1400 in which the lost and found service 510 shares the lost item data 1205 directly with the social network service 515. Alternatively, the social network service may automatically receive access to the lost item data when the user uses the social network service to submit the form data to the lost and found service. With the users' permission, the social network service may store within memory digital profiles 1410 associated with each account set-up for their users, including user 110 as graphically depicted by numeral 1405. As further depicted in FIG. 14, these digital profiles can include individualized data about each of their users, including connections 1415 (e.g., friends, followers, following), interests 1420, and hobbies 1425. Interests can include genres of music and movies/television shows the user enjoys, and hobbies can include activities with which the user partakes, such as playing a musical instrument or a particular sport. Due to the data retrieved from the lost item form, the social network service can additionally store definitive data about products of interest 1430 or potential interest for the user. For example, the lost item data is valuable because it is indicative of an actual item purchased or at least used by the user, and that the user values the item sufficiently to go through the trouble to submit a lost item form.

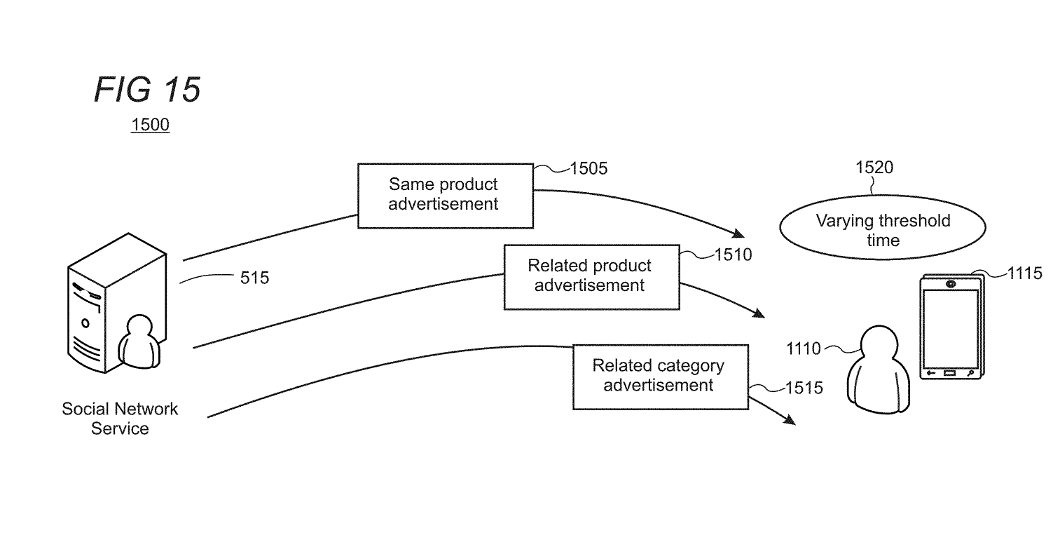

FIG. 15 shows an illustrative environment 1500 in which the social network service 515 transmits advertisements to users based on the updated digital profile depicted in FIG. 14. For example, using the lost item data the social network service can transmit advertisements to the user's devices for the same product 1505 as the one which the user lost, related products 1510 to the item which was lost, and related category 1515 products to the item which was lost. The advertisements can be in the form of banners on the user's screen, pop-up videos, pictures, etc.

Using the details from the lost item data, the social network can attempt to identify the same exact product as the one which the user lost, and thereby transmit advertisements to the user for the item.

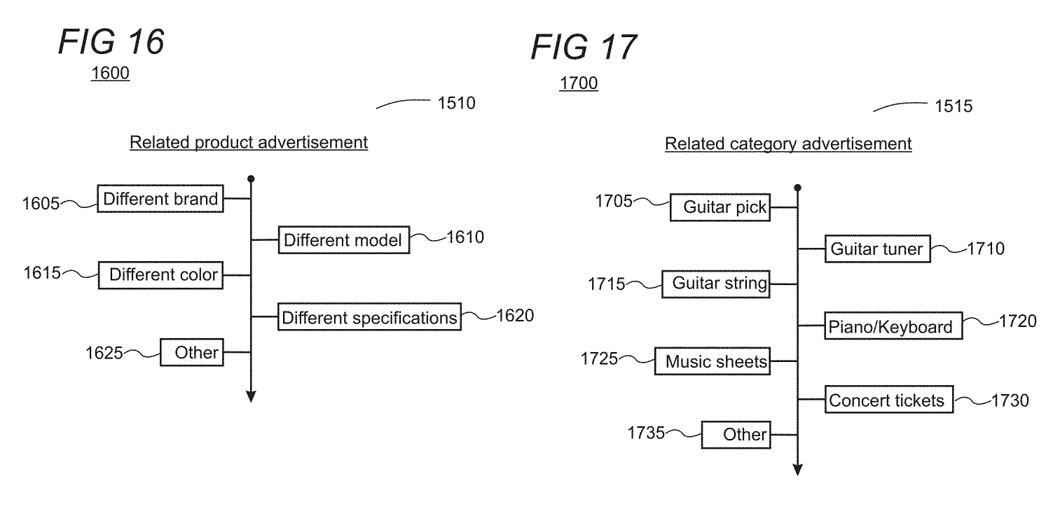

FIG. 16 shows an illustrative taxonomy 1600 in which items with differences from the lost item can be identified and advertised to the user. For example, related products but with different characteristics to the lost item can be one or more of products of a different brand 1605, different model 1610, different color 1615, different specifications 1620, or other differences 1625 from the lost item. Thus, the related products can be products that are the same type of product as the item which was lost, but have different characteristics from the lost item. For example, if a Windows® laptop is lost, then a related item would be a Windows® laptop with a faster processor, a different color external shell, or even a different manufacturer such as Apple® or Dell®. These are all laptops like the lost item, but with varying characteristics.

FIG. 17 shows an illustrative taxonomy 1700 in which items within a related category to the lost item can be identified and advertised to the user. In this example, the taxonomy is based on the lost guitar from FIG. 7 for exemplary discussion. Items related to the guitar can include a guitar pick 1705, guitar tuner 1710, guitar string 1715, piano/keyboard 1720, music sheets 1725, concert tickets 1730, and other items 1735 related to a guitar. Thus, categorically related items can be items that are associated with or share a particular group designation with the lost item. The shared designation can be a broad category (e.g., music) and may further break down into sub-categories. For example, the broad category for the guitar example can fall into the category of music generally, which further breaks down into a string instrument category, which further breaks down into guitar category, and then further breaks down into acoustic or electric guitar category. Thus, the social network service can identify related categories based on any one or more of the categories and sub-categories associated with the particular item.

Referring back to FIG. 15, the advertisements may be prevented from transmission until a threshold duration of time passes, as represented by numeral 1520. The threshold duration of time may vary depending on the type of advertisement and/or until a condition is satisfied. For example, if there is a subsequent match for the user's lost item in which the user's item is retrieved, the service may decide not to transmit an advertisement for the same exact product. However, the service may decide any subsequent time would be beneficial to either transmit a related product advertisement or a related category advertisement.

Furthermore, if a user immediately uploads a lost item form, the service may decide to wait a few days or weeks before offering replacement advertisements for the lost item. In contrast, categorical advertisements may be advantageous to transmit shortly after the lost item form is uploaded since related items (e.g., a guitar pick for a lost guitar) are not a replacement advertisement but rather something in which the user may always be interested. Thus, the predetermined thresholds of time may be set for each type of advertisement 1505, 1510, and 1515 before the service can automatically begin generating and transmitting advertisements to the user.

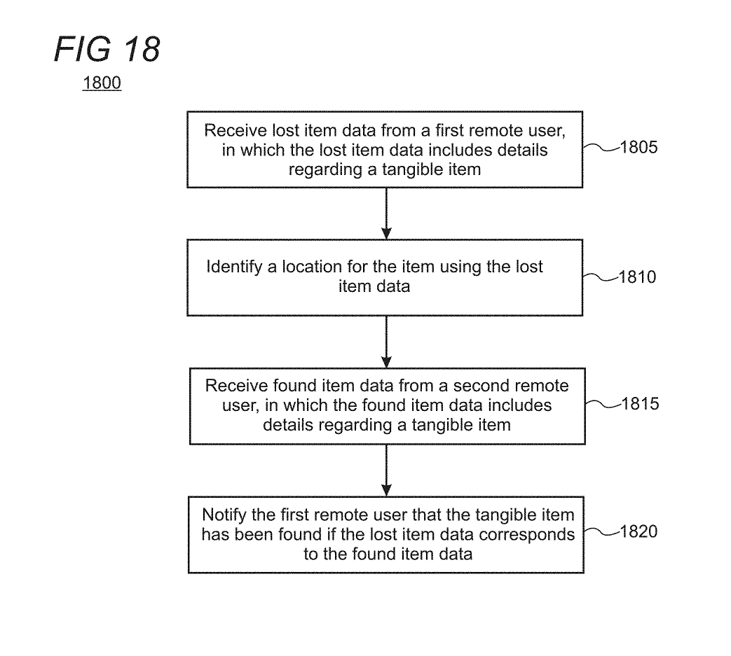

FIG. 18 is a flowchart of an illustrative method 1800 for gathering and locating lost items for users. Unless specifically stated, methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 1805 a server receives, from a first remote user associated with a first computing device, lost item data, in which the lost item data includes details regarding a tangible item (FIG. 2). In step 1810, a location is identified for the item using the lost item data. The location may be derived directly from the lost item data or may be identified based on the application used to submit the lost item data. For example, if the lost item data came from an application for an amusement park, ballpark, museum, and the like, then the server can identify the location associated with the application. That is, if the application is submitted from a MOMA application, then the server may designate the location as MOMA, a geographic region, or MOMA's address.

In step 1815, the server receives from a second remote user associated with a second computing device found item data that provides details regarding a tangible item. In step 1820, the server determines whether the found item data corresponds to the lost item data. If the found item data corresponds to the lost item data, the server notifies at least the first remote user that the tangible item associated with the lost item data has been found.

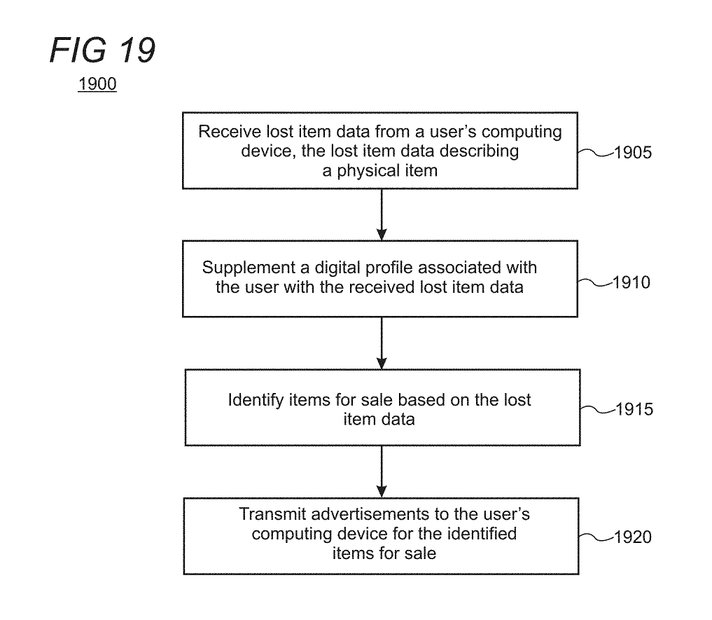

FIG. 19 is a method 1900 performed by a server to update a digital profile for a user to improve marketing efforts. In step 1905, lost item data is received from a computing device that describes a physical item. In step 1910, a digital profile associated with a user is supplemented with the lost item data. In step 1915, items for sale are identified based on the lost item data. In step 1920, advertisements for the identified items for sale are transmitted to the computing device.

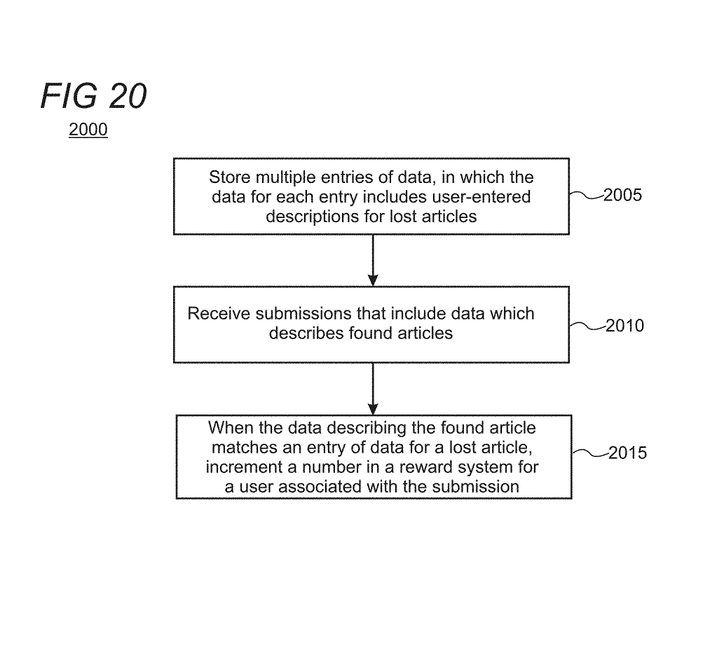

FIG. 20 is a method 2000 performed by a computing device in which an incentive program is implemented. In step 2005 multiple entries of data are stored, in which the data for each entry includes user-entered descriptions for lost articles. In step 2010, submissions are received that include data that describes found articles. In step 2015, when the data describing the found article matches an entry of data for a lost article, increment a number in a reward system for a user associated with the submission.

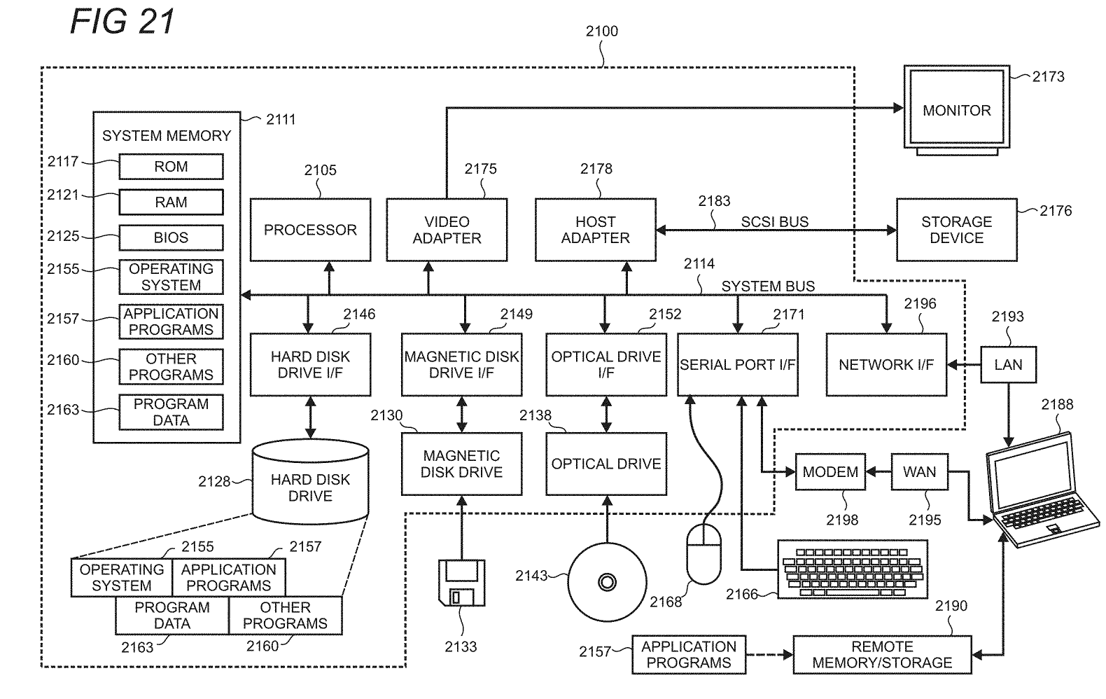

FIG. 21 is a simplified block diagram of an illustrative computer system 2100 such as a PC, client machine, or server with which the present usable inferences based on user's updated digital profile may be implemented. Computer system 2100 includes a processor 2105, a system memory 2111, and a system bus 2114 that couples various system components including the system memory 2111 to the processor 2105. The system bus 2114 may be any of several types of bus structures including a memory bus or memory controller, a peripheral bus, or a local bus using any of a variety of bus architectures. The system memory 2111 includes read only memory (ROM) 2117 and random access memory (RAM) 2121. A basic input/output system (BIOS) 2125, containing the basic routines that help to transfer information between elements within the computer system 2100, such as during startup, is stored in ROM 2117. The computer system 2100 may further include a hard disk drive 2128 for reading from and writing to an internally disposed hard disk (not shown), a magnetic disk drive 2130 for reading from or writing to a removable magnetic disk 2133 (e.g., a floppy disk), and an optical disk drive 2138 for reading from or writing to a removable optical disk 2143 such as a CD (compact disc), DVD (digital versatile disc), or other optical media. The hard disk drive 2128, magnetic disk drive 2130, and optical disk drive 2138 are connected to the system bus 2114 by a hard disk drive interface 2146, a magnetic disk drive interface 2149, and an optical drive interface 2152, respectively. The drives and their associated computer-readable storage media provide non-volatile storage of computer-readable instructions, data structures, program modules, and other data for the computer system 2100. Although this illustrative example includes a hard disk, a removable magnetic disk 2133, and a removable optical disk 2143, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present cloud-based lost and found service. In addition, as used herein, the term computer-readable storage media includes one or more instances of a media type (e.g., one or more magnetic disks, one or more CDs, etc.). For purposes of this specification and the claims, the phrases “computer-readable memory devices,” “computer-readable storage media” and variations thereof, are non-transitory and do not include waves, signals, and/or other transitory and/or intangible communication media.

A number of program modules may be stored on the hard disk, magnetic disk 2133, optical disk 2143, ROM 2117, or RAM 2121, including an operating system 2155, one or more application programs 2157, other program modules 2160, and program data 2163. A user may enter commands and information into the computer system 2100 through input devices such as a keyboard 2166 and pointing device 2168 such as a mouse. Other input devices (not shown) may include a microphone, joystick, game pad, satellite dish, scanner, trackball, touchpad, touchscreen, touch-sensitive device, voice-command module or device, user motion or user gesture capture device, or the like. These and other input devices are often connected to the processor 2105 through a serial port interface 2171 that is coupled to the system bus 2114, but may be connected by other interfaces, such as a parallel port, game port, or universal serial bus (USB). A monitor 2173 or other type of display device is also connected to the system bus 2114 via an interface, such as a video adapter 2175. In addition to the monitor 2173, personal computers typically include other peripheral output devices (not shown), such as speakers and printers. The illustrative example shown in FIG. 21 also includes a host adapter 2178, a Small Computer System Interface (SCSI) bus 2183, and an external storage device 2176 connected to the SCSI bus 2183.

The computer system 2100 is operable in a networked environment using logical connections to one or more remote computers, such as a remote computer 2188. The remote computer 2188 may be selected as another personal computer, a server, a router, a network PC, a peer device, or other common network node, and typically includes many or all of the elements described above relative to the computer system 2100, although only a single representative remote memory/storage device 2190 is shown in FIG. 21. The logical connections depicted in FIG. 21 include a local area network (LAN) 2193 and a wide area network (WAN) 2195. Such networking environments are often deployed, for example, in offices, enterprise-wide computer networks, intranets, and the Internet.

When used in a LAN networking environment, the computer system 2100 is connected to the local area network 2193 through a network interface or adapter 2196. When used in a WAN networking environment, the computer system 2100 typically includes a broadband modem 2198, network gateway, or other means for establishing communications over the wide area network 2195, such as the Internet. The broadband modem 2198, which may be internal or external, is connected to the system bus 2114 via a serial port interface 2171. In a networked environment, program modules related to the computer system 2100, or portions thereof, may be stored in the remote memory storage device 2190. It is noted that the network connections shown in FIG. 21 are illustrative and other means of establishing a communications link between the computers may be used depending on the specific requirements of an application of the present usable inferences based on user's updated digital profile.

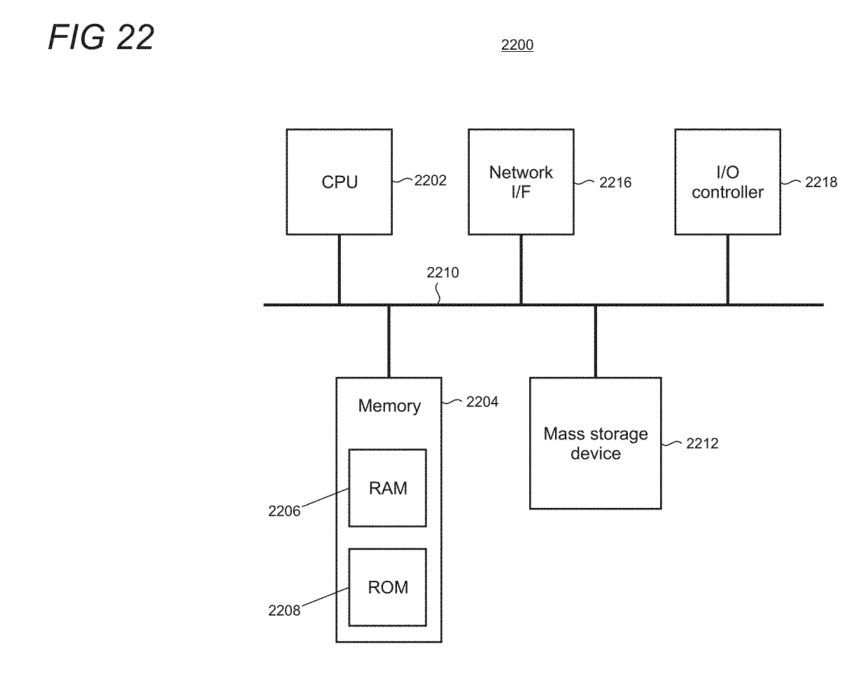

FIG. 22 shows an illustrative architecture 2200 for a device capable of executing the various components described herein for providing the present cloud-based lost and found service. Thus, the architecture 2200 illustrated in FIG. 22 shows an architecture that may be adapted for a server computer, mobile phone, a PDA, a smartphone, a desktop computer, a netbook computer, a tablet computer, GPS device, gaming console, and/or a laptop computer. The architecture 2200 may be utilized to execute any aspect of the components presented herein.

The architecture 2200 illustrated in FIG. 22 includes a CPU (Central Processing Unit) 2202, a system memory 2204, including a RAM 2206 and a ROM 2208, and a system bus 2210 that couples the memory 2204 to the CPU 2202. A basic input/output system containing the basic routines that help to transfer information between elements within the architecture 2200, such as during startup, is stored in the ROM 2208. The architecture 2200 further includes a mass storage device 2212 for storing software code or other computer-executed code that is utilized to implement applications, the file system, and the operating system.

The mass storage device 2212 is connected to the CPU 2202 through a mass storage controller (not shown) connected to the bus 2210. The mass storage device 2212 and its associated computer-readable storage media provide non-volatile storage for the architecture 2200.

Although the description of computer-readable storage media contained herein refers to a mass storage device, such as a hard disk or CD-ROM drive, it should be appreciated by those skilled in the art that computer-readable storage media can be any available storage media that can be accessed by the architecture 2200.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 2200.

According to various embodiments, the architecture 2200 may operate in a networked environment using logical connections to remote computers through a network. The architecture 2200 may connect to the network through a network interface unit 2216 connected to the bus 2210. It should be appreciated that the network interface unit 2216 also may be utilized to connect to other types of networks and remote computer systems. The architecture 2200 also may include an input/output controller 2218 for receiving and processing input from a number of other devices, including a keyboard, mouse, or electronic stylus (not shown in FIG. 22). Similarly, the input/output controller 2218 may provide output to a display screen, a printer, or other type of output device (also not shown in FIG. 22).

It should be appreciated that the software components described herein may, when loaded into the CPU 2202 and executed, transform the CPU 2202 and the overall architecture 2200 from a general-purpose computing system into a special-purpose computing system customized to facilitate the functionality presented herein. The CPU 2202 may be constructed from any number of transistors or other discrete circuit elements, which may individually or collectively assume any number of states. More specifically, the CPU 2202 may operate as a finite-state machine, in response to executable instructions contained within the software modules disclosed herein. These computer-executable instructions may transform the CPU 2202 by specifying how the CPU 2202 transitions between states, thereby transforming the transistors or other discrete hardware elements constituting the CPU 2202.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 2200 in order to store and execute the software components presented herein. It also should be appreciated that the architecture 2200 may include other types of computing devices, including handheld computers, embedded computer systems, smartphones, PDAs, and other types of computing devices known to those skilled in the art. It is also contemplated that the architecture 2200 may not include all of the components shown in FIG. 22, may include other components that are not explicitly shown in FIG. 22, or may utilize an architecture completely different from that shown in FIG. 22.

The subject matter described above is provided by way of illustration only and is not to be construed as limiting. Various modifications and changes may be made to the subject matter described herein without following the example embodiments and applications illustrated and described, and without departing from the true spirit and scope of the present invention, which is set forth in the following claims.

What is claimed:

1. A method operating on a server that is in communication with a plurality of computing devices over a network, the method comprising:
receiving from a first remote user associated with a first computing device, lost item data that provides details regarding a tangible item;
identifying a location for the item using the lost item data;
receiving from a second remote user associated with a second computing device, found item data that provides details regarding a tangible item;
determining whether the found item data corresponds to the lost item data; and
if the found item data is determined to correspond to the lost item data, notifying the first remote user that the tangible item associated with the lost item data has been found.

2. The method of claim 1, further comprising configuring the method to operate with third party applications and services.

3. The method of claim 2, in which a third party application is configured to detect terms input into the first computing device, such that the detected terms are used as the lost item data that provides details of the tangible item.

4. The method of claim 3, in which the determined correspondence is based on comparing analogous parts and sub-parts of the lost item data and the found item data.

5. The method of claim 2, further comprising an artificial intelligence (AI) component configured to recognize behaviors associated with the first remote user or the first computing device and infer, based on the recognized behaviors, that the first remote user has lost the tangible item, in which the AI component automatically provides the first remote user with a fillable lost item form.

6. The method of claim 1, in which the location includes at least a defined geographic region or a geographic region associated with a name of a place.

7. The method of claim 1, if the lost item data is not found to correspond to the found item data for the tangible item or found item data for other tangible items, transmit an advertisement to the remote user that reflects the tangible item.

8. The method of claim 1, further comprising:
identifying an account for the second remote user in response to the remote user transmitting the found item data that provides details regarding the tangible item; and
when the found item data results in a verified correspondence with the lost item data, providing a reward to the account for the second remote user.

9. The method of claim 8, in which the reward includes incrementing one or more of points or monetary amounts associated with the second remote user's account.

10. A server, comprising:
one or more processors;
one or more memory devices storing computer-readable instructions which, when executed by the one or more processors, cause the server to:
receive lost item data describing a physical item from a computing device;
supplement a digital profile associated with a user of the computing device with the lost item data;
identify items for sale based on the lost item data; and
transmit advertisements for the identified items for sale to the computing device.

11. The server of claim 10, in which the items for sale are identified for being the same as the item data.

12. The server of claim 11, in which the items for sale are identified as being the same type of item as the physical item but with different characteristics.

13. The server of claim 12, in which the different characteristics can include items that are one or more of a different brand, different model, different color, or different specification.

14. The server of claim 10, in which the instructions further cause the server to:
derive categorical data from the item data; and
identify items for sale on the categorical data.

15. The server of claim 14, in which the categorical data includes one or more categories with which the item data is associated, and wherein the instructions further cause the server to:
compare the one or more categories for the lost item data with categories associated with items for sale;
identify items for sale associated with categories that match the one or more categories for the lost item data;
transmit advertisements for the identified items for sale;

16. The server of claim 15, in which the server is prohibited from transmitting advertisements to the user's computing device for a threshold duration of time after the user submits the lost item data.

17. The server of claim 10, in which types of advertisements are assigned varying threshold durations of time or a condition before the server is permitted to transmit the respective advertisement, in which different types of advertisements include advertisements that are directed to the same product as the lost physical item, advertisements that are directed to the same product as the lost physical item but with different characteristics, and advertisements that are directed to the same category as the lost physical item but not the same item.

18. The server of claim 10, in which the instructions further cause the server to update the user's digital profile to reflect the user's interest in the physical item.

19. One or more non-transitory computer-readable memory devices storing instructions which, when executed by one or more processors disposed in a computing device, cause the computing device to:
store multiple entries of data, in which the data for each entry includes user-entered descriptions for lost articles;
receive submissions that include data which describes found articles; and
when the data describing the found article matches an entry of data for a lost article, incrementing a number in a reward system for a user associated with the submission.

20. The one or more non-transitory computer-readable memory devices of claim 19, in which the reward system changes depending on the application with which a lost and found client operates, such that each application is configured to implement a proprietary reward system.
